(19) United States
(12) Patent Application Publication
(10) Pub. No.: US 2007/0216808 A1
(43) Pub. Date: Sep. 20, 2007

(54) SYSTEM, METHOD, AND APPARATUS FOR SCALING PICTURES

(76) Inventors: Alexander G. MacInnis, Ann Arbor, MI (US); Greg Kranawetter, Laguna Hills, CA (US); Sandeep Bhatia, Bangalore (IN); Robin (Shen-yung) Chen, Fremont, CA (US); Mahadhevan Sivagururaman, Tirupur (IN); Srilakshmi Dorarajulu, Bangalore (IN)

Correspondence Address: MCANDREWS HELD & MALLOY, LTD, 500 WEST MADISON STREET, SUITE 3400, CHICAGO, IL, 60661, US

(21) Appl. No.: 11/550,755

(22) Filed: Oct. 18, 2006

Related U.S. Application Data
(63) Continuation-in-part of application No. 10/611,451, filed on Jun. 30, 2003.
(60) Provisional application No. 60/727,982, filed on Oct. 18, 2005.

(51) Int. Cl. H04N 7/00

(52) U.S. Cl. 348/581

(57) ABSTRACT

Presented herein are systems and methods for scaling. In one embodiment, there is presented a method for scaling. The method comprises receiving a top field and a bottom field, detecting whether the top field and bottom field correspond to the same time period, and generating a scaled field for display using both the top field and bottom field, if the top field and the bottom field correspond to the same time period.

### RELATED APPLICATIONS

This application claims priority to “System, Method, and Apparatus for Scaling Pictures”, U.S. Application for Patent Ser. No. 60/727,982, filed Oct. 18, 2005, which is incorporated herein by reference.

This application is a continuation-in part of U.S. Application for patent Ser. No. 10/611,451, filed Jun. 30, 2003 by MacInnis, et. al., which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video data can be filmed in a variety of formats and displayed in a variety of formats. The formats can be characterized by, for example, pixel dimensions, speed, and progressive versus interlaced.

Pixel dimensions measure the number of pixels that are along the horizontal and vertical dimensions of the frame. Two common formats are known as standard definition (SD) and high definition (HD). Standard definition is typically considered to be 720 pixels horizontally×480 pixels vertically. High definition is typically considered to be either 1920 pixels horizontally×1080 pixels vertically or 1280 pixels horizontally×720 pixels vertically.

Speed indicates the number of frames per second.

Common formats are film mode, and NTSC. Film mode typically uses approximately 24 frames per second, while NTSC uses approximately 30 frames per second.

In interlaced format, a top field, i.e. either the even or odd numbered lines, of a frame is associated with one time period, while a bottom field, i.e. the alternate set of lines, is associated with an adjacent time period. In progressive format, all of the lines of the frames are associated with one time period.

Video data can be captured in one format and displayed in another format. For example, motion pictures are usually captured using 24 progressive frames per second, while a high definition display may display video content at 30 high definition interlaced frames per second or 60 high definition frames per second.

Additionally, compression standards, such as MPEG-2, are often used to transport video data over a communication medium to a terminal device. The MPEG-2 standard can encode and identify video data as having been encoded using either interlaced or progressive techniques.

In many cases where the display is interlaced, the MPEG-2 standard encodes and identifies the video data as intended for interlaced display where the video data was captured and encoded using progressive methods. For example, a video encoder may individually encode the entire progressive frames of video data captured using film mode at 24 frames per second and mark them for display at 30 interlaced frames per second.

Conversion of 24 progressive frames to 30 interlaced frames per second is accomplished using what is known as 3:2 pull down. In 3:2 pull down, out of every four fields, one field is repeated. It is noted that the repeated field can be either a top field or bottom field.

Conversion of pixel dimensions is accomplished using what is known as scaling. Scaling converts the frame size of the video data to the frames size of the display device and may occur in the horizontal and/or vertical direction.

When the video data is to be upscaled (the pixel dimensions of the display exceed the pixel dimensions of the video data), the quality of the display can become an issue. Generally, the more information in the original video data that is available for upscaling, the better the quality of the upscaled picture, while the less information in the original video data, the lower the quality of the upscaled picture.

This becomes particularly important in cases where video data that is indicated as interlaced is upscaled. As noted above, there are cases where progressive content is encoded and indicated as interlaced. As a result, fields may be used for upscaling.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the present invention may be found in system(s), method(s), and apparatus for scaling pictures, substantially as shown in and/or described in connection with at least one of the figures, as set forth more completely in the claims.

These and other advantages and novel features of the present invention, as well as illustrated embodiments thereof will be more fully understood from the following description and drawings.

### BRIEF DESCRIPTION OF SEVERAL VIEWS OF THE DRAWINGS

FIG. 1 is an illustration of scaling in accordance with an embodiment of the present invention;

FIG. 2 is a flow diagram for scaling in accordance with an embodiment of the present invention;

FIG. 3 is a block diagram of an exemplary circuit in accordance with an embodiment of the present invention;

FIG. 4 is an illustration describing the encoding of video data in accordance with an exemplary video compression standard;

FIG. 5 is a block diagram of an exemplary decoder in accordance with an embodiment of the present invention;

FIG. 6 is a block diagram of an exemplary display engine in accordance with an embodiment of the present invention; and

FIG. 7 is a flow diagram describing for scaling pictures in accordance with an embodiment of the present invention.

### DETAILED DESCRIPTION OF THE INVENTION

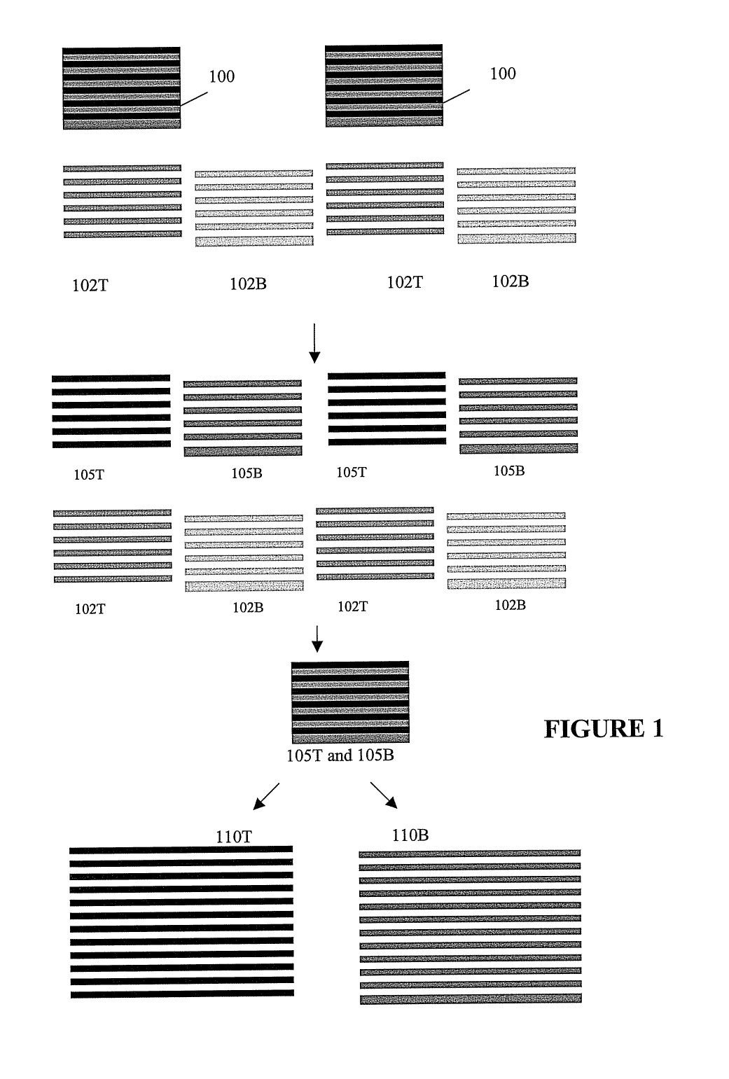

Referring now to FIG. 1, there is illustrated a block diagram describing scaling in accordance with an embodiment of the present invention. Video data comprises a series of frames.

The frames can either be progressive 100 or interlaced 102. In the case of an interlaced frame 102, one set of alternating lines, e.g., the even numbered lines of the frame 102T (will now be referred to as the top field) are captured and correspond to one period of time, while the other set of alternating lines, e.g, odd-numbered lines of the frame 102B (will now be referred to as the bottom field) are captured and correspond to an adjacent period of time. In the case of progressive frames 100, the lines are captured during the same time period. It is noted that while in this specification, the top field shall refer to the even numbered lines and the bottom field shall refer to the odd-numbered lines, the top field is not required to include the even numbered lines and the bottom field is not required to include the odd numbered lines.

The frames 100/102 can be transmitted over a communications media for display on display devices (such as TVs, or monitors). Display devices that are either interlaced or progressive can display the video data comprising frames 100 or 102. For example, a CRT-based television set may display the top field during one time period and the bottom field during an adjacent time period.

In cases where the progressive frames 100 are to be displayed on an interlaced display device, the progressive frames 100 can be transmitted as top fields 105T and bottom fields 105B. However, in this case, the top field 105T and bottom field 105B are the even and odd-numbered lines from a progressive frame 100. The data contained in the top field 105T and bottom field 105B are captured and correspond to the same time period. In contrast, the top field 102T and bottom field 102B correspond to different time periods.

The display devices also can display fields 110 with different pixel dimensions. In certain embodiments of the present invention, the frames 110 can comprise more lines than the frames 100/102. Where the display device displays frames 110 with different pixel dimensions from frames 102/105, the received frames 102/105 are scaled.

Scaling can be improved by the use of both the top field 105T and bottom field 105B if the top fields 105T and bottom field 105B are captured at and correspond to the same time period. Accordingly, top field 110T is generated using both top field 105T and bottom field 105B for scaling, where the top field 105T and bottom field 105B are captured at and correspond to the same time period. Bottom field 110B is also generated using both top field 105T and bottom field 105B for scaling, where the top field 105T and bottom field 105B are captured at and correspond to the same time period.

However, if top field 102T and bottom field 102B are not captured at and corresponding to the same time period, top field 102T should be used for generating top field 110T and bottom field 102B should be used for generating bottom field 110B.

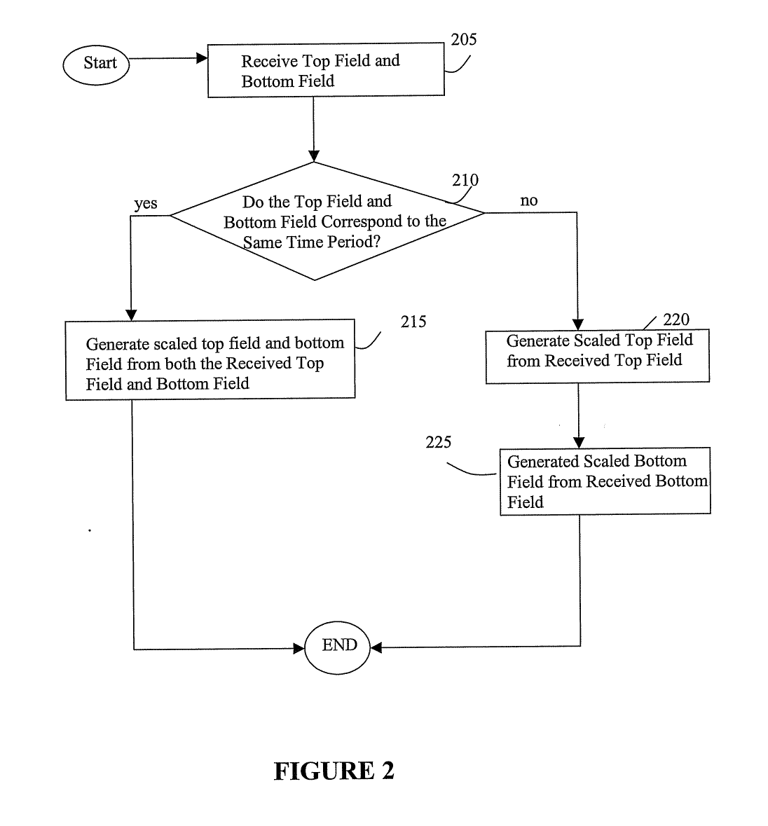

Referring now to FIG. 2, there is illustrated a flow diagram for scaling in accordance with an embodiment of the present invention. FIG. 2 will be described with reference to FIG. 1.

At 205, top field and bottom field are received. At 210, a determination is made whether the received top field and bottom field correspond to the same time period. If the top field and bottom field correspond to the same time period, e.g., top field 105T and bottom field 105B, then top field 110T and bottom field 110B are each generated using both the top field 105T and the bottom field 105B at 215.

If at 210, the top field and bottom field do not correspond to the same time period, e.g., top field 102T and bottom field 102B, then top field 110T is generated for display using top field 105T (at 220), and bottom field 110B is generated for display using bottom field 105B (at 225).

The determination of whether the top field and bottom field correspond to the same time period can be made in a variety of ways. In certain embodiments of the present invention, parameters associated with the top field and bottom field can be examined. The parameters can include, for example, parameters that are indicative of 3:2 pull down, such as top field first and repeat first field.

In other embodiments of the present invention, the determination can be based on time stamps associated with the top field and bottom field. The time stamps indicate the time of display for the top field and bottom field.

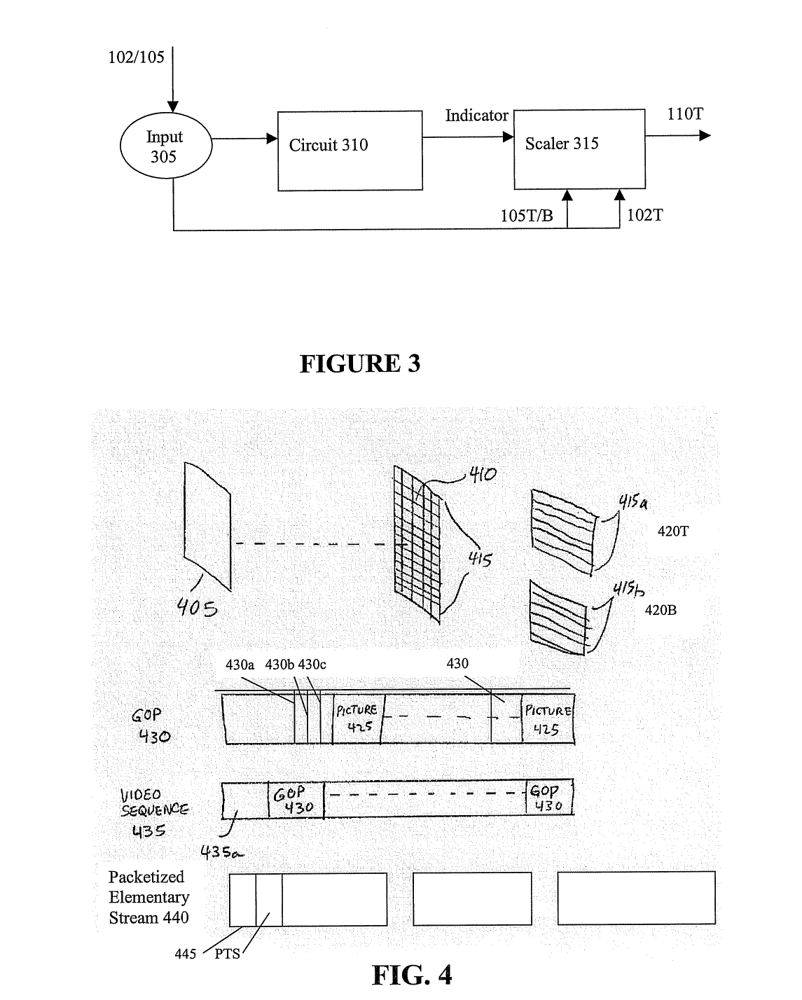

Referring now to FIG. 3, there is illustrated a block diagram of an exemplary circuit 300 in accordance with an embodiment of the present invention. The circuit 300 comprises an input 305, circuit 310, and a scaler 315.

The input 305 receives the top 102T/105T and bottom fields 102B/105B. The circuit 310 determines whether a top field 102T/105T and bottom field 102B/105B correspond to the same time period, e.g., top field 105T and bottom field 105B, and provides an indicator to the scaler 315 indicating the whether the top field 102T/105T and bottom field 102B/105B correspond to the same time period.

The circuit 310 can comprise for example, logic gates, hardware accelerators, or processor(s) executing instructions. The circuit 310 can determine whether a top field 102T/105T and bottom field 102B/105B correspond to the same time period in a variety of ways. In certain embodiments of the present invention, parameters associated with the top field and bottom field can be examined. The parameters can include, for example, parameters that are indicative of 3:2 pull down, such as top field first and repeat first field. In other embodiments of the present invention, the determination can be based on time stamps associated with the top field and bottom field. [May be??? let's talk about this.] The time stamps indicate the time of display for the top field and bottom field.

The scaler 315 generates top field 110T and bottom field 110B. The scaler 315 generates the top field 110T using only a top field 102T, and a bottom field 110B using only a bottom field 102B, where the indicator indicates that the top field and bottom field, e.g., top field 102T and bottom field 102B, correspond to different time periods. If the indicator indicates that the top field and bottom field, e.g., top field 105T and bottom field 105B, correspond to the same time period, the scaler 315 generates the top field 110T using both the top field 105T and bottom field 105B and generates the bottom field 110B using the top field 105T and bottom field 105B.

The foregoing can be incorporated in the context of particular video compression standards. An exemplary video compression standard, MPEG-2, will now be described, followed by a decoder system in accordance with an embodiment of the present invention, and flow charts for scaling in accordance with embodiments of the present invention.

Referring now to FIG. 4, there is illustrated a block diagram describing the MPEG-2 encoding process. A video comprises a series of successive frames 405. The frames comprise two-dimensional grids of pixels 410, wherein each pixel 410 in the grid corresponds to a particular spatial location of an image captured by the camera. Each pixel 410 stores a color value describing the color of the spatial location corresponding thereto. Accordingly, each pixel 410 is associated with two spatial parameters (x,y) as well as a time parameter associated with the frame.

The pixels 410 are produced by the scanning operation of a video camera. A progressive camera scans each row 415 of a frame 405 in one time interval, e.g. from top to bottom. In contrast, an interlaced camera scans the even rows 415a from top to bottom at a first time interval, and the odd rows 415b from top to bottom at a second time interval. The even rows 415a form a two dimensional grid of pixels 410 with half as many lines as the frame, forming a field, e.g. a top field 420T. Similarly, the odd rows 415b include a grid that forms a second field, e.g. a bottom field 420B. An interlaced frame 405 comprises the top field 420T and the bottom field 420B.

The MPEG-2 standard uses a variety of algorithms that take advantage of both spatial and temporal redundancies to compress the frames 405 in a data structure known as a picture 425. In the case where the frames 405 are interlaced, the picture 425 can either include the top field 420T and bottom field 420B, or each picture 425 can include only one of the fields 420T, 420B.

In cases where the progressive frames 405 are to be displayed on an interlaced display device, the progressive frames 405 may be compressed as progressive frames and marked with values of top-field-first and repeat-first-field syntax elements to enable direct conversion to interlaced display format. However, in this case, the top field 420T and bottom field 420B come from a progressive frame 100. The top field 420T and bottom field 420B are captured and correspond to the same time period.

The picture 425 also includes a header 430. The header 430 stores a number of parameters. These parameters can include indicators indicating whether the picture 425 is progressive or interlaced 430a, repeat first field 430b, and top field first 430c, among others.

The repeat first field 430b and top field first 430c indicators can be used for what is known as 3:2 pull down. The 3:2 pull down is used to display film mode frames 405 on an NTSC display, for example. Film mode frames 405 are progressive frames that are captured at approximately 24 progressive frames per second. An NTSC display displays approximately 30 interlaced frames per second.

Film mode frames 405 can be displayed by generating top fields 420T from the even-numbered lines and bottom fields 420B from the odd-numbered lines of the frames 405. This results in approximately 48 interlaced fields per second. Out of every four consecutive fields, one field is repeated, resulting in approximately 60 interlaced fields per second. It is noted that the order in which the top field 420T and bottom field 420B of a frame 405 are displayed will change.

The repeat first field indicator 430b indicates whether the first field in the picture 425 should be repeated. The top field first indicator 430c indicates whether the top field is to be displayed first. Where 3:2 pull down is used, the repeat first field indicator 430b and top field first indicator 430c will repeat the following pattern:

| | RFF | TFF |
|---|---|---|
| Picture n | 0 | 1 |
| Picture n + 1 | 1 | 1 |
| Picture n + 2 | 0 | 0 |
| Picture n + 3 | 1 | 0 |

The pictures 425 are grouped into another structure known as a group of pictures 430. The video 400 is represented by a video sequence 435 that includes a header 435a, and any number of groups of pictures 430.

The video sequence 435 can then be packetized forming what is known as the packetized elementary stream 440. The packetized elementary stream 440 includes a header 445. The header 445 includes time stamps, and can include a presentation time stamp PTS and a decode time stamp DTS. The packetized elementary stream 440 can then be placed into what are known as transport packets. The transport packets can be transmitted over a communication medium to decoder systems, which may be connected to display devices. The transport stream is received at a decoder system that decodes the video sequence 435 to recover the video 400.

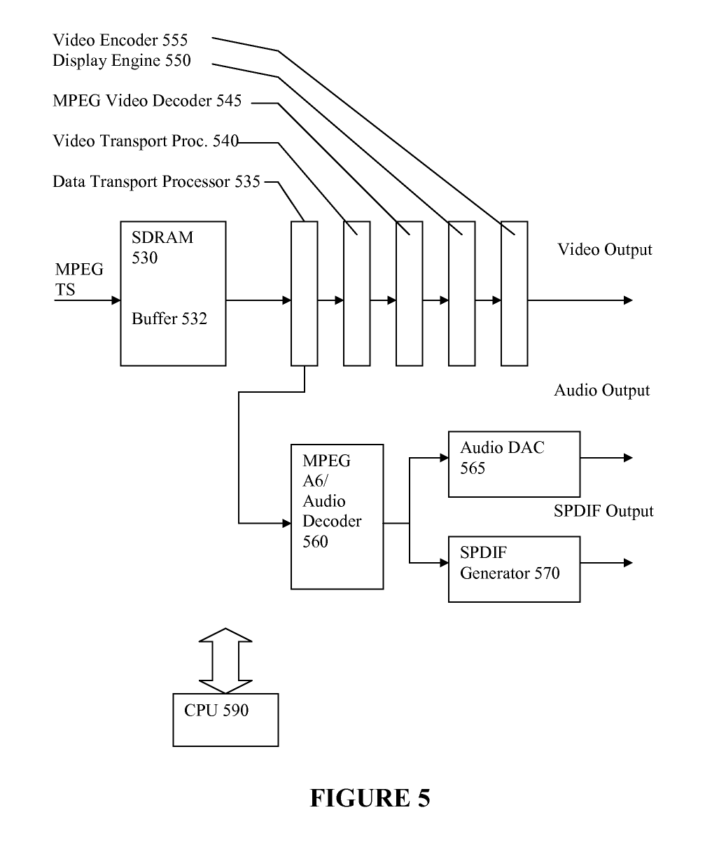

Referring now to FIG. 5, there is illustrated a block diagram of an exemplary decoder in accordance with an embodiment of the present invention. Data is output from buffer 532 within SDRAM 530. The data output from the buffer 532 is then passed to a data transport processor 535. The data transport processor 535 demultiplexes the transport stream and passes the audio transport packets to an audio transport processor 560 and then to an MPEG audio decoder, and the video transport packets to a video transport processor 540 and then to an MPEG video decoder 545. The audio data is then sent to the output blocks, and the video is sent to a display engine 550.

The display engine 550 scales the video picture, resulting in fields 110T, 110B, renders the graphics, and constructs the complete display. Once the display is ready to be presented, it is passed to a video encoder 555 where it is converted to analog video using an internal digital to analog converter (DAC). The digital audio is converted to analog in an audio digital to analog converter (DAC) 565.

The display engine 550 receives the top field 420T and bottom field 420B and determines whether the top field and bottom field correspond to the same time period. The display engine 550 generates the top fields 110T using only top fields 420T, and bottom fields 110B using only bottom field 420B, where the top fields and bottom fields correspond to different time periods. However, if the top fields 420T and bottom fields 420B correspond to the same time periods, the display engine 550 generates the top fields 110T using both the top fields 420T and bottom fields 420B and generates the bottom fields 110B using both the top fields 420T and bottom fields 420B. In certain embodiments of the present invention, the display engine 550 can comprise the circuit 310 of FIG. 3.

The display engine 550 can detect whether the top fields 420T and bottom fields 420B correspond to the same time period in a variety of ways. In one embodiment, the display engine 550 can detect whether the top fields 420T and bottom fields 420B correspond to the same time period by examining the repeat first field 330b and top field first 330c indicators. If the indicators 330b, 330c follow the pattern of 3:2 pull down, the display engine 550 detects that the top fields 420T and bottom fields 420B correspond to the same time period. Also, if a 3:2 pattern is detected, it's possible to construct 24 progressive frames/second from the available fields, which can be thought of as inverting the 3:2 pulldown pattern. The resulting 24 progressive frames/second can be scaled as described here, resulting in improved quality.

In another embodiment, the display engine 550 can examine the indicator 330a that indicates whether the picture 425 is progressive or interlaced. If the indicator 330a indicates that the picture 425 is progressive for a predetermined number of consecutive pictures, the display engine 550 detects that the top fields 420T and bottom fields 420B correspond to the same time intervals. If the indicator does not indicate so, the display engine 550 does not detect the foregoing.

In another embodiment, where the display engine 550 determines that fields 420T and 420B correspond to different time periods, the display engine 550 can deinterlace fields 420T and 420B, forming a progressive frame, and use the progressive frame for generating fields 110T and 110B.

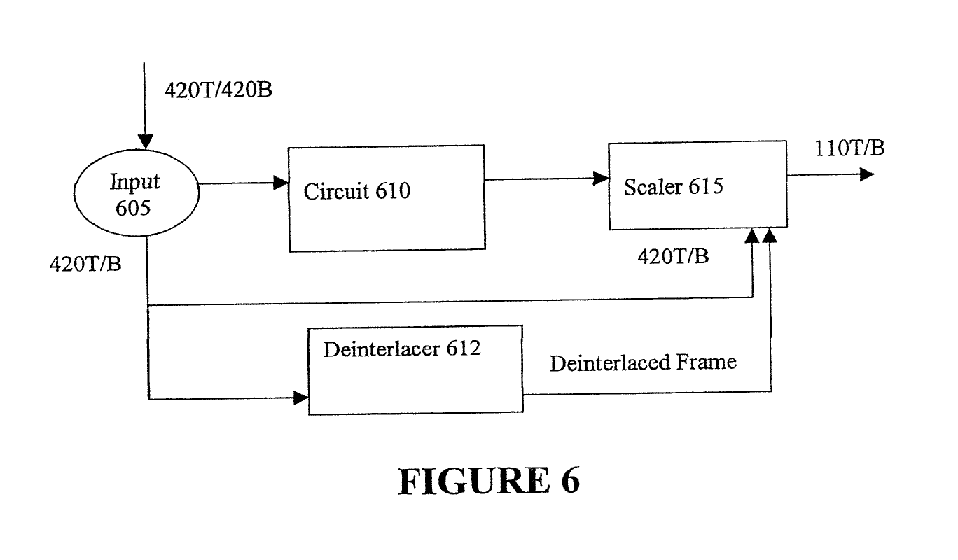

Referring now to FIG. 6, there is illustrated a block diagram of an exemplary display engine in accordance with an embodiment of the present invention. The display engine 550 comprises an input 605, circuit 610, a deinterlacer 612, and a scaler 615.

The input 605 receives the top 420T and bottom fields 420B. The circuit 610 determines whether a top field 420T and bottom field 420B correspond to the same time period, and provides an indicator to the scaler 615 indicating the whether the top field 420T and bottom field 420B correspond to the same time period. The circuit 610 can comprise for example, logic gates, hardware accelerators, or processor(s) executing instructions.

The scaler 615 generates top field 110T and bottom field 110B. If the indicator indicates that the top field and bottom field correspond to the same time periods, e.g., top field 105T and bottom field 105B, the scaler 615 generates the top field 110T using both the top field 105T and bottom field 105B and generates the bottom field 110B using both the top field 105T and bottom field 105B.

Where the indicator indicates that the top field 110T and bottom field 110B correspond to different time periods, deinterlacer 612 deinterlaces top field 110T and bottom field 110B, thereby generating a deinterlaced frame. The scaler 615 uses the deinterlaced frame generated by the deinterlacer 612 to generate top field 110T and bottom field 110B.

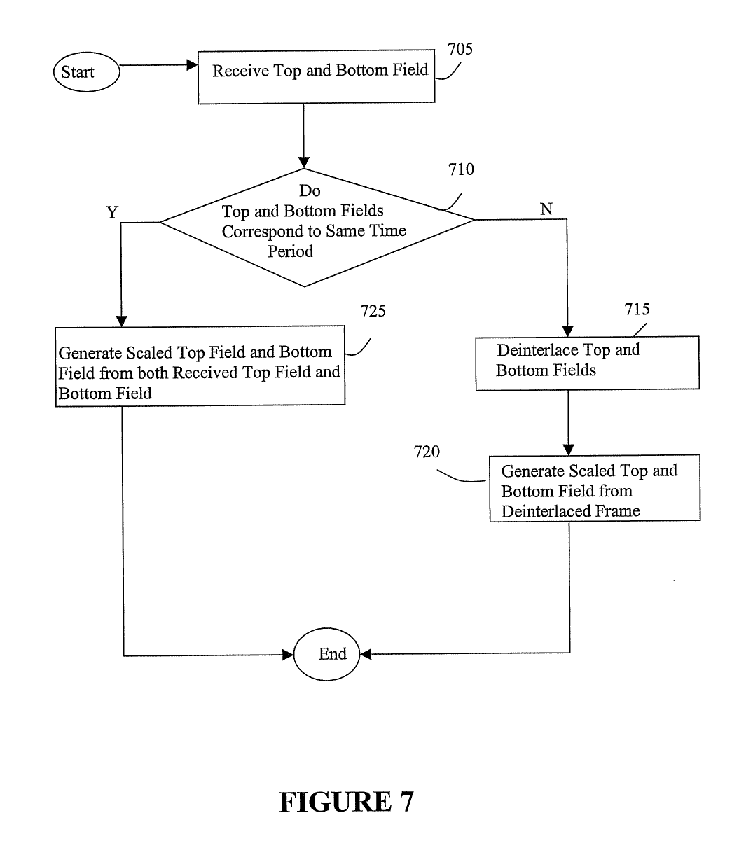

Referring now to FIG. 7, there is illustrated a flow diagram for scaling in accordance with an embodiment of the present invention. At 705, the top field and bottom field are received at input 605. At 710, circuit 610 determine whether the top field and bottom field correspond to the same time period by either, examining the repeat first field 430b and top field first parameters 430c, examining the PTS, or examining the indicator 430a indicating progressive frames.

If at 710, the circuit 610 determines that the top field and bottom field correspond to different time periods, at 715 the deinterlacer 612 deinterlaces the top and bottom fields, generating a deinterlaced frame.

At 720, the scaler 615 generates top field 110T and bottom field 110B from the deinterlaced frame from deinterlacer 612.

If at 710, the circuit 610 determines that the top field and bottom field correspond to the same time periods, at 725, the scaler 615 generates top field 110T and bottom field 110B using both the top field and bottom fields.

The embodiments described herein may be implemented as a board level product, as a single chip, application specific integrated circuit (ASIC), or with varying levels of the system integrated with other portions of the system as separate components. Alternatively, if the processor is available as an ASIC core or logic block, then the commercially available processor can be implemented as part of an ASIC device wherein certain aspects of the present invention are implemented as firmware.

The degree of integration may primarily be determined by speed and cost considerations. Because of the sophisticated nature of modern processors, it is possible to utilize a commercially available processor, which may be implemented external to an ASIC implementation.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1-16. (canceled)

17. A method for presenting an interlaced frame, said method comprising:
deinterlacing the interlaced frame, thereby resulting in a deinterlaced frame; and
scaling the deinterlaced frame.

18. The method of claim 1, further comprising:
decoding the interlaced frame.

19. The method of claim 2, wherein decoding the frame further comprises:
decompressing the frame, thereby resulting in the interlaced frame.

20. A system for presenting interlaced frames, said system comprising:
a video decoder for decoding interlaced frames;
a deinterlacer for deinterlacing the interlaced frames, thereby resulting in deinterlaced frames; and
a display engine for scaling the deinterlaced frames.

21. The system of claim 4, wherein the video decoder further comprises:
a decompression engine for decompressing the interlaced frames.

22. The system of claim 5, wherein the video decoder comprises:
an MPEG-2 video decoder for decompressing the interlaced frames.

23. A system for presenting interlaced frames, said system comprising:
a video decoder for decoding interlaced frames, the decoder further comprising a deinterlacer for deinterlacing the interlaced frames, thereby resulting in deinterlaced frames; and
a display engine for scaling the deinterlaced frames.

24. The system of claim 7 wherein the decoder further comprises:
a decompression engine for decompressing the interlaced frames.

25. A system for presenting interlaced frames, said system comprising:
a video decoder for decoding interlaced frames;
a display engine for scaling deinterlaced frames, wherein the display engine further comprises a deinterlacer for deinterlacing the interlaced frames, thereby resulting in the deinterlaced frames.

26. The system of claim 9, wherein the display engine further comprises a scaler for scaling the deinterlaced frames.

27. A circuit for presenting interlaced frames, said circuit comprising:
a processor; and
a memory connected to the processor, said memory storing a plurality of instructions executable by the processor, wherein execution of the plurality of instructions by the processor cause:
receiving interlaced frames;
deinterlacing the interlaced frames; and
scaling the deinterlaced frames.

28. The circuit of claim 11, wherein execution of the plurality of instructions by the processor further causes:
decoding the interlaced frames.

29. The circuit of claim 11, wherein execution of the plurality of instructions by the processor further causes:
decompressing the interlaced frames.

30. A decoder for decoding interlaced frames, said decoder comprising:
a decompression engine for decompressing the interlaced frames; and
a deinterlacer for deinterlacing the interlaced frames.

31. A display engine for scaling interlace frames, said display engine comprising:
a deinterlacer for deinterlacing the interlaced frames, thereby resulting in deinterlaced frames; and
a scaler for scaling the deinterlaced frames.
